(19) United States
(12) Patent Application Publication
(10) Pub. No.: US 2012/0203790 A1
(43) Pub. Date: Aug. 9, 2012

(54) Table-driven and data-driven method, and computer-implemented apparatus and usable program code for data integration system for heterogeneous data sources dependent upon the table-driven and data-driven method

(76) Inventor: B. Victor Cariri, Casa Grande, AZ (US)

(21) Appl. No.: 13/020,690

(22) Filed: Feb. 3, 2011

(51) Int. Cl. G06F 17/30

(52) U.S. Cl. 707/756; 707/E17.005

(57) ABSTRACT

A table-driven and data-driven method to map multiple enterprise systems' databases and a data integration system that uses this table-driven and data-driven method to supply the logic and business rules contained within the tables of its processing database to fully integrate any two heterogeneous data sources. The system can also use the table-driven and data-driven method to integrate multiple data sources to multiple other data sources. The system can detect any changed data structures in the data sources and automatically update the import and integration processes to accommodate those changes. The computer-implemented apparatus and usable program code also provides a graphical user interface to quickly create the data for the table-driven and data-driven method for a specific heterogeneous data source and destination pairing.

### CROSS-REFERENCE TO RELATED APPLICATIONS

| | | |
|---|---|---|
| 5,884,310 | March 1999 | Brichta, et al |
| 6,519,598 | February 2003 | Nishizawa, et al |
| 7,257,594 | August 2007 | Tamboli, et al |
| 7,600,001 | October 2009 | Groh, et al |
| 7,650,608 | January 2010 | Patel, et al |

Please see data under BACKGROUND OF THE INVENTION for detail on the relationship between these applications and this patent application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Endeavor

This invention relates to improvement in data integration between heterogeneous databases and, more particularly, to the integration of data between enterprise software systems such as ERP, CRM, PLM, and others.

2. Description of Prior Art

As business has become increasingly dependent upon technology for efficient function, a variety of computer and software systems have been developed to facilitate various aspects of business. Major enterprise systems such as ERP, CRM, PLM, and other major systems have aided businesses in specific aspects of their processes, however, each has been developed on a unique database structure, which has prevented these enterprise systems from effectively sharing data. Therefore, if a customer account has been created or updated in an ERP, that customer account would also need to be manually created or updated in the CRM, leading to higher operating costs as well as the possibility of human error or oversight resulting in incompatible views of the same customer account.

To resolve the issue, companies have had to resort to the creation of custom software systems or highly customized software packages to integrate these enterprise datasets. These systems have been time consuming to create or implement, often taking in excess of six months, as well as costly, often costing in excess of $100,000. In addition, these systems have been heavily dependent on custom code, which leaves them highly susceptible to failure in the (common) event of a data structure change with the upgrade of an enterprise system. This can result in serious financial harm to the business as it tries to repair the broken integration system(s). Siebel made a highly invasive data structure change in the upgrade from Siebel Version 6 to Version 7. CIO.com's take on what happened to AT&T Wireless at the time as a result? The storyline: “The story of a botched CRM upgrade that cost the telco thousands of new customers and an estimated $100 million in lost revenue.”

The most recent trend is to create and market ‘connectors’ that purport to facilitate the integration of one specific pairing of enterprise systems. They may help to some degree, but lack any flexibility, not designed to integrate any other pairings of systems. These will be susceptible to the same weaknesses as fully custom integration applications.

(U.S. Pat. No. 7,650,608 to Bea Systems, Inc. and Patel, et al. “System and method for application and resource data integration” While this system purports to provide data integration, what it actually does is to allow system A to use data from system B by having system B export data into a standardized XML format which is then imported into system A. There is no real claim to integrate the datasets.)

(U.S. Pat. No. 7,600,001 to Vignette Corporation and Groh, et al. “Method and computer system for unstructured data integration through a graphical interface” This is a data import method, not a data integration method as it does not account for updates to existing data. It includes a graphical mapping interface that is used to map an unstructured data source, such as a web file, to a structured destination, such as a database. Data Integration between enterprise systems requires that both the data source and data destination be structured. There is no real claim to integrate any datasets, nor is there any claim to store any mapping data from the GUI into a database for later recall and use.)

(U.S. Pat. No. 7,257,594 to Petris Technology Corporation and Tamboli, et al. “Method, system, and product for data integration through a dynamic common model” This method and system is simply a data import system, not a data integration system as it takes a record in one database in its native format and translates it to a standardized system format through a system adaptor, then translates the system format to the destination system format through a second adapter to insert a record. It takes into account data types and parameters. There is no real claim to integrate any datasets, nor is there any claim to use a GUI to create mapping data nor a data structure to save the mapping and recall for later use. The system does use catalog keys and does apparently catalog the active system adaptors.)

(U.S. Pat. No. 6,519,658 to Hitachi, Ltd. and Nishizawa, et al. “Active memory and memory control method, and heterogeneous data integration use system using the memory and method” This is an on-demand system that takes a request for information from a client computer, retrieves the information from a magnetic disk apparatus, converts it to what is needed by the client system, and supplies that data in a view to the client system. It makes no claim to insert or update information in any database underlying the system running on the client computer. It is not claimed to be either table or data driven. It does claim a graphical method of representation of the field mapping. It is merely a way to visually display information from one system, presumably a mainframe, on another system, presumably a PC. There is no real claim to integrate any datasets.)

(U.S. Pat. No. 5,884,310 to Electronic Data Systems Corporation and Brichta, et al. “Distributed data integration method and system” This data integration method and system creates a common database server and system. Data from enterprise systems is imported into their common database server, being used as a universal database, and they have an application to view that information. They do a system import from an enterprise system into their universal database for viewing purposes, but make no claim to integrate a source enterprise system's database to a destination enterprise system's database.)

### BRIEF SUMMARY OF THE INVENTION

A table-driven and data-driven method to map multiple enterprise systems' databases and a data integration system that uses this table-driven and data-driven method to supply the logic and business rules contained within the tables of its processing database to fully integrate any two heterogeneous data sources. The system can also use the table-driven and data-driven method to integrate multiple data sources to multiple other data sources. The system can detect any changed data structures in the data sources and automatically update the import and integration processes to accommodate those changes. The computer-implemented apparatus and usable program code also provides a graphical user interface to quickly create the data for the table-driven and data-driven method for a specific heterogeneous data source and destination pairing.

As noted elsewhere in this document, the basic problems with data integration systems to this point is that they are very time-consuming and costly to implement, very inflexible, heavily dependent on custom code, and in many cases, severely restricted as to systems they will integrate. Being fully table-driven, our method and computer implemented apparatus enable quick configuration (under one month), low fixed cost, easily accommodates any systems, and will easily and quickly accommodate any data structure changes.

### BRIEF DESCRIPTION OF THE SEVERAL VIEWS OF THE DRAWING

Embodiments of the invention will now be described with reference to the accompanying drawings wherein:

FIG. 1 is a schematic diagram of the relationship and interaction of a small subset of the configuration tables in the Processing Database. The database tables shown comprise a section of the tables that will be used to configure the specific step of analyzing the data found in the working tables (not shown) to detect and process new and updated records for submission to the destination system.

Note: The table and field structure as shown in FIG. 1 uses specific table and field names, however, the method described in section 1 of this summary and claim 1 of this application is independent of specific table and field names. The specific table and field names as shown in FIG. 1 and as described in this summary are for illustrative purposes only.

FIG. 2 is a schematic diagram of a potential network diagram on an enterprise level. The central system (Data Integration Server) being the invention here applied for, representing the Table & Data-Driven Method, the computer-implemented apparatus and usable program code server for the Data Integration Configurator, the computer-implemented apparatus and usable program code server for the Data Integration Processor, and the Database Server for the Processing Database.

### DETAILED DESCRIPTION OF THE INVENTION

### Definitions

Table-driven/data-driven: A table or data-driven system is one that draws the information it needs to manage its processing from a database, with data stored in database tables and fields, not in code as found in the computer-implemented apparatus and usable program code. In effect, the computer-implemented apparatus and usable program code writes its own code as it runs.

Usable program code: Source code that can be compiled and will execute as designed.

Business Rules: For this application, we consider business rules to be rules such as order of processing, which data will prevail when two databases hold differing information, whether specific data should be updated at the destination or not, validation rules, and so forth.

Runtime: When something is said to happen runtime, it means that it is defined and only available while the computer-implemented apparatus and usable program code is running.

Codes/Code Tables: Codes are commonly used to represent a detailed description, as the code “A” or the code “1” might be used to represent the status of “Active.” Code tables store the code values and their descriptions.

Data Import/Migration: This is a term for a unidirectional insertion of data from one system's database into another system's database. This is distinct from Data Integration because there is a failure to update records in the destination database after an update to an existing record in the source database.

Data Integration: Though his term is commonly misapplied to a simple Data Import or Migration, a Data Integration both inserts new records from a source database into a destination database and also processes updates in the destination database when a record has been changed in the source database. A Data Integration can be unidirectional or bidirectional.

Enterprise System: This is a system based on a server or mainframe that enables the entire company to function effectively. Examples are: ERP Enterprise Resource Planning, CRM Customer Relationship Management, PLM Product Lifecycle Management.

Database: For this application, we will blur distinctions between disparate systems, such as the data structure of an IBM Midrange (Files/Columns) and a server-based database (Tables/Columns), and we will consider any structured and normalized data to reside in a database. Common database systems are Oracle, MS SQL Server, Sybase, and MySQL.

Data Source: The enterprise system's database that is the source of the information that is being processed.

Data Destination: The enterprise system's database that is the destination of the information that is being processed.

Data Map: An entity that keeps track of the relationship of table and field data between differing database structures. In a Table-Driven and Data-Driven system, this information will be stored in a series of database tables. In custom data integration systems, this information will typically be incorporated into the source code itself.

Data Structure: Consists of the tables and fields of a database, the data types, such as integer or text, the field sizes and other properties. In a Table-Driven and Data-Driven system, this information will be used extensively as SQL code is constructed runtime.

Processing Database: The database that contains the data used to implement the method of claim 1, configured by the computer-implemented apparatus and usable program code of claim 2, and used by the computer-implemented apparatus and usable program code of claim 3 to process data from the source database, ultimately identifying new and updated records and integrating the data.

Configuration Tables: The tables populated by the computer-implemented apparatus and usable program code of claim 2 to implement the method of claim 1.

Working Tables: For this application, the working tables are tables that are created by the system for a specific data integration process, and are used runtime to integrate the data.

### DETAILED DESCRIPTION

As noted above, there is a widespread need to integrate data between enterprise systems as there will be information common to disparate systems. For example, the ERP will hold data about Customer Accounts, Products, and Sales Orders for the purpose of taking and processing orders, collections, and accounting. The CRM will also hold data about Customer Accounts, Products, and Sales Orders so that the Sales team can see account activity associated with their Customer Contacts. Product data will be found in the ERP, the CRM, the PLM, and likely other systems as well. How can companies ensure that these separate enterprise systems all reflect the correct information? Only through a true data integration. Systems available to this point are far too time consuming and costly to implement, and too vulnerable to total failure in the (common) event of data structure changes with enterprise system version upgrades.

In broad terms, the system according to the invention is designed to allow a very rapid deployment, a low cost, the power to handle multiple enterprise system pairings, and the flexibility to allow extremely quick adjustments, without working in source code, to handle data structure changes due to version upgrades. To accomplish this, the method and related systems will be completely Table and Data-Driven. Changes to data structures or growing information needs will solely require adjustments to records in the Processing Database, not to any source code. The system consists of three parts:

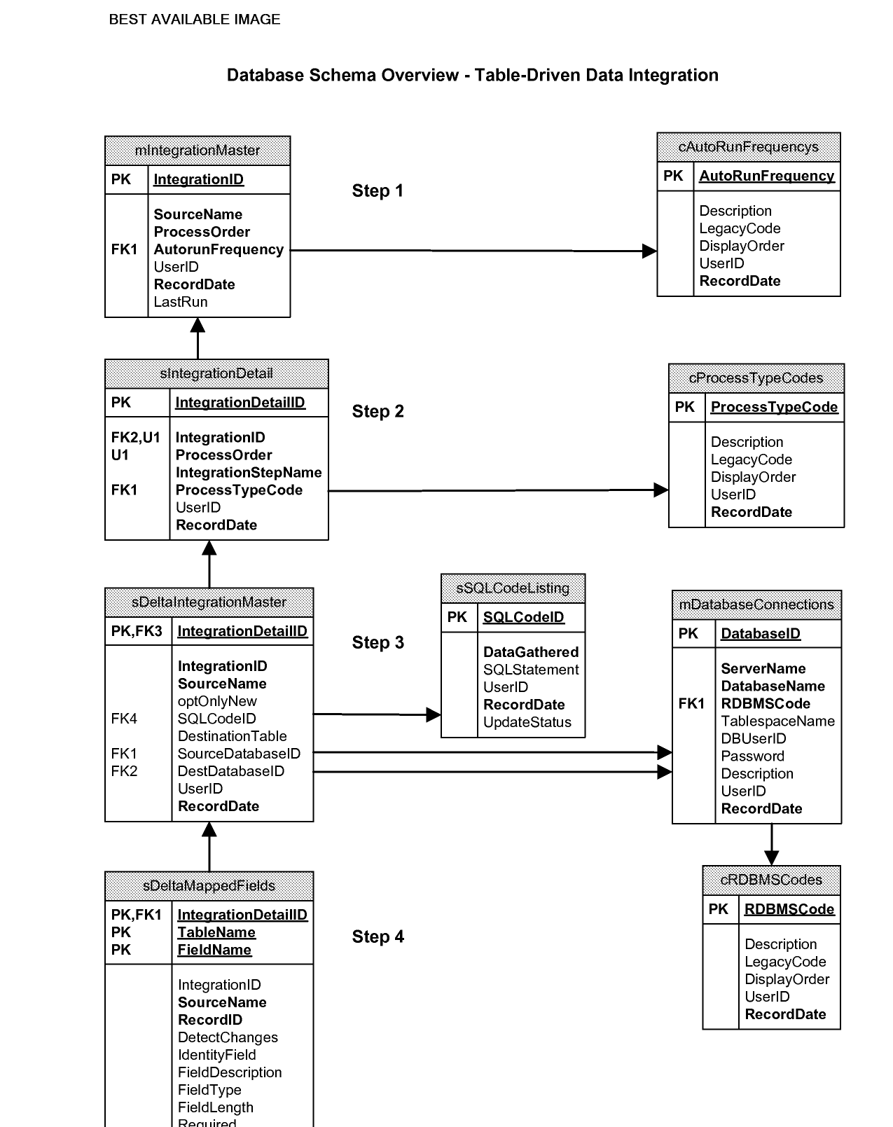

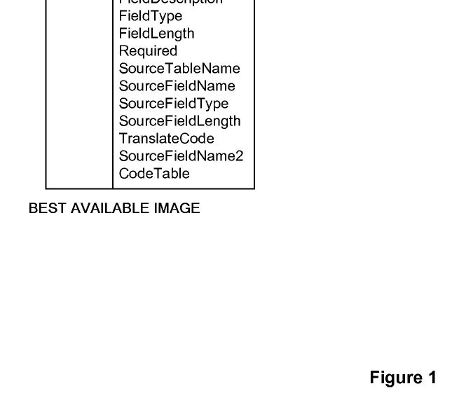

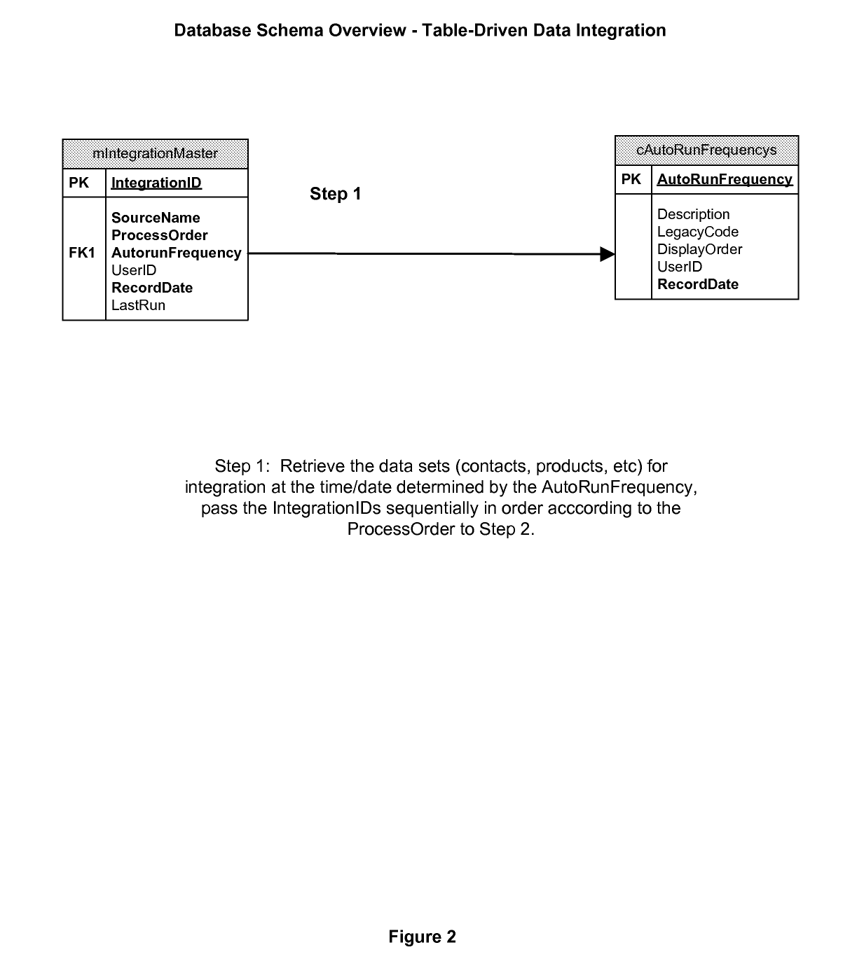

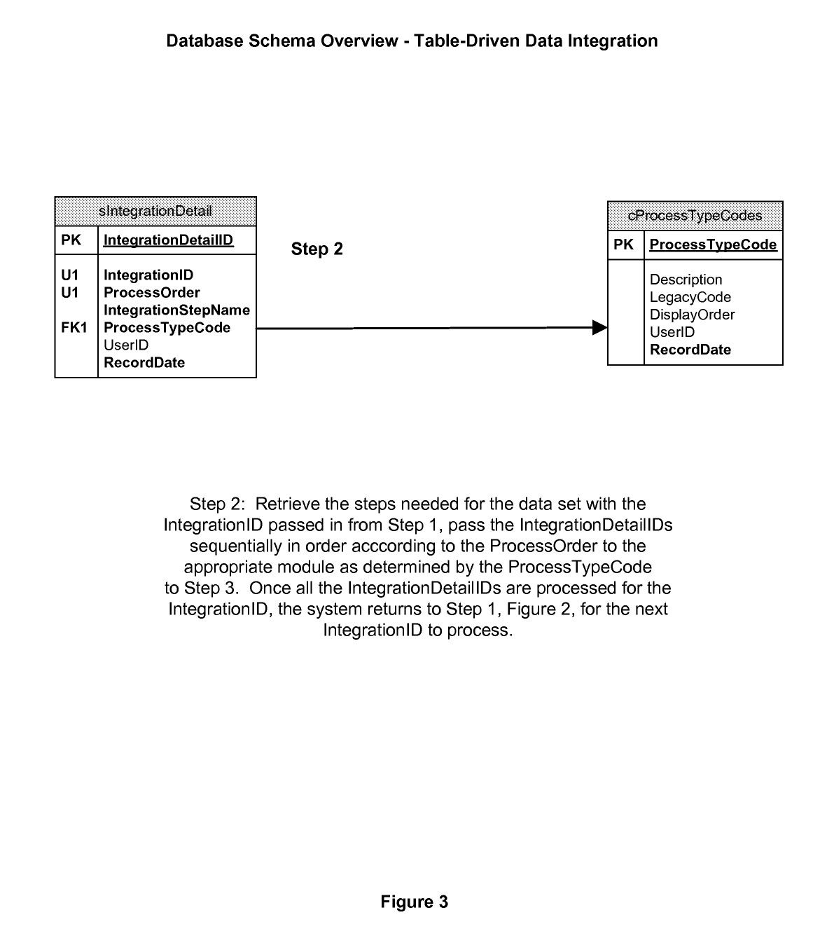

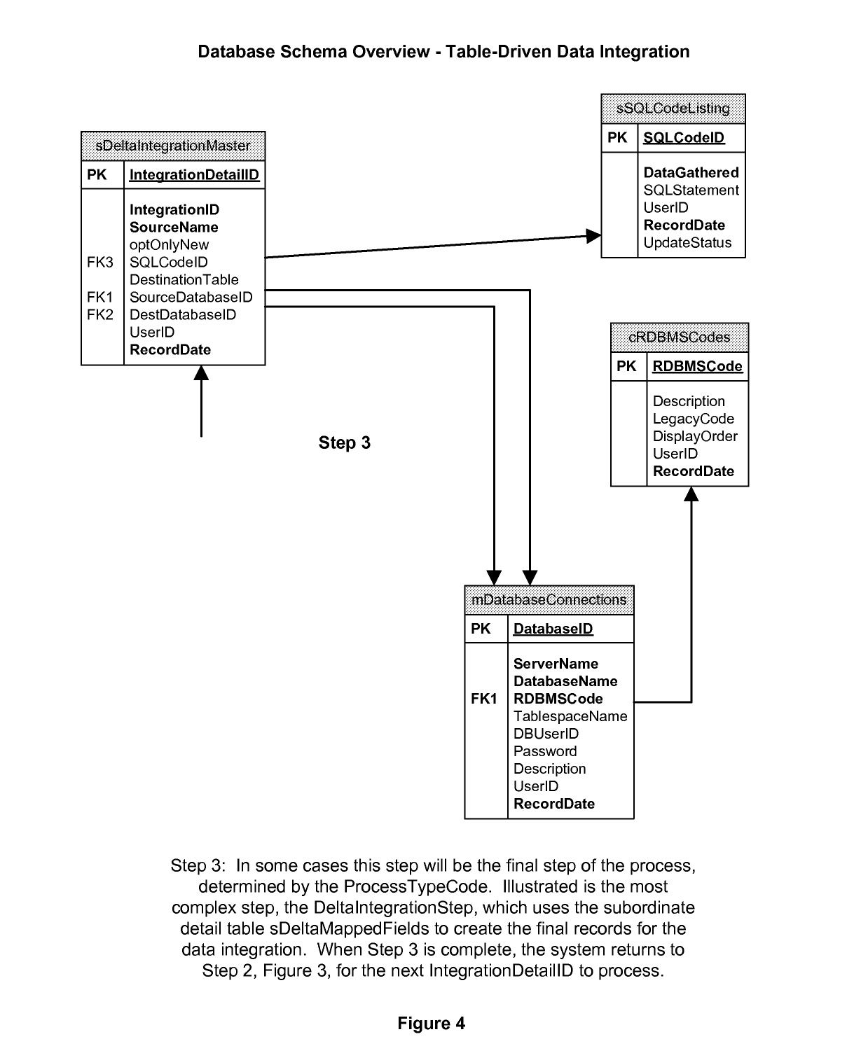

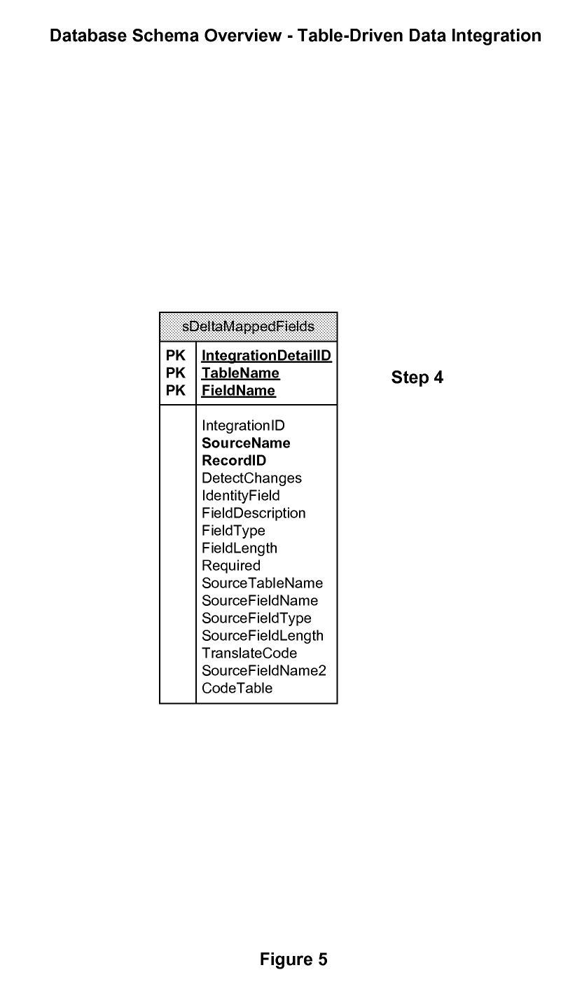

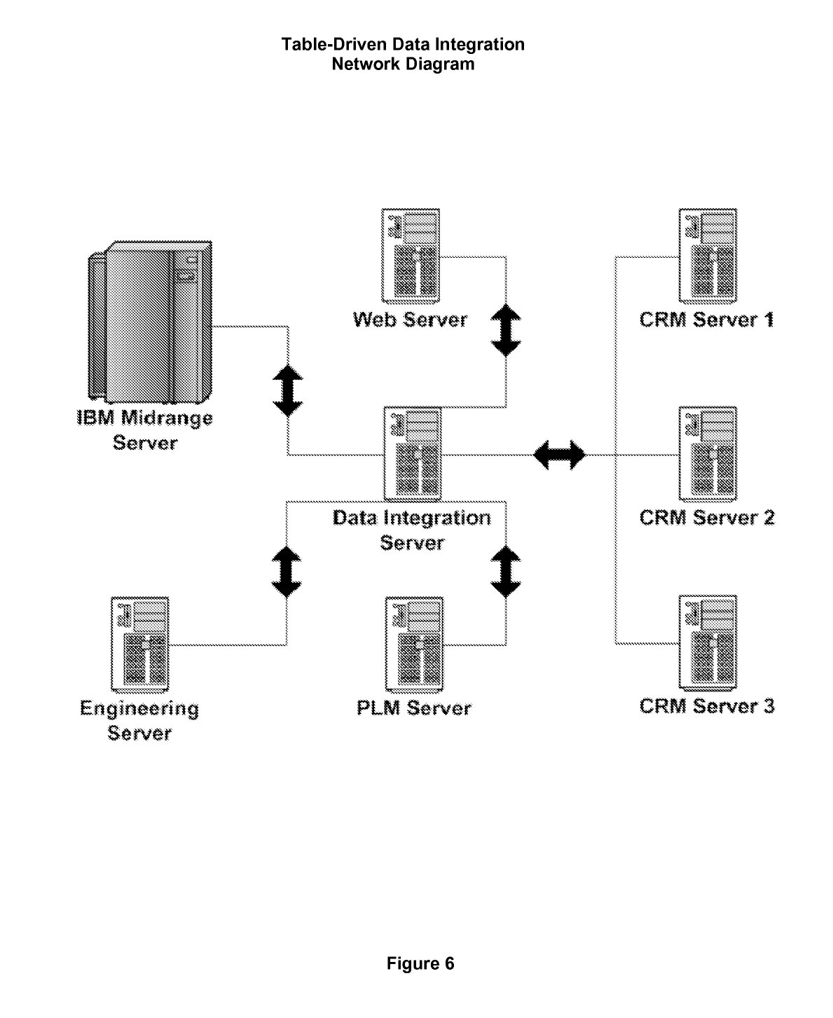

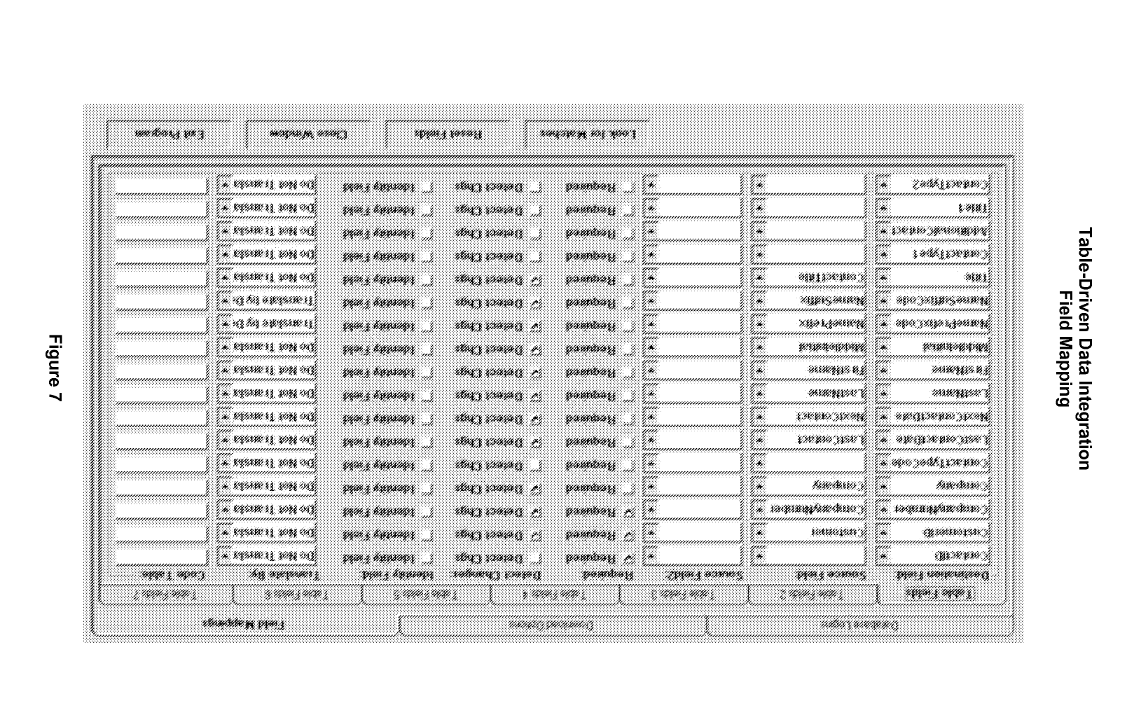

Part 1: A table-driven and data-driven method to follow a detailed sequence of data integration steps as stored in a Processing Database; map multiple enterprise systems' database structures by data section (e.g. Customer Data, Contact Data, Product Data, Sales Order Data and so forth), storing this Map in a Processing Database; hold within this Processing Database information permitting flexibility of processing, such as supplying records for the destination enterprise system to import versus directly editing information as found in the destination enterprise system database; hold within this Processing Database information as to what the method should process at a given time of day and day of week; hold within this Processing Database details on Business Rules to be applied to the data integration. (Please see FIG. 1 in the drawings document.) These business rules will include details such as fields to be integrated as well as fields found within the data section to be left unchanged in the destination database; hold within this Processing Database details on connections to Source and Destination databases for the data integration; hold within this Processing Database a history of the data as submitted to the Destination database; hold within this Processing Database all information needed to be available to enable SQL code to be constructed in runtime; and, read source and destination table data structure to enable proper formatting of system generated code runtime.

Included in the data structure is the ability to define any number of process types, each one of which can be processed by the processor. Additional process types can be defined and added to the data structure at will. FIG. 1 in the drawings document shows a subset of the table structure used to define one of the common pre-defined process types.

Part 2: A computer-implemented apparatus and usable program code to provide a graphical user interface to enable a user to quickly construct the data as needed to implement the table-driven and data-driven method. (Please see FIG. 1 in the drawings document.) This computer-implemented apparatus and usable program code will be referred to as the Data Integration Configurator.

As is seen in FIG. 1 and in Section 3 to follow (the Data Integration Processor), the method described in section 1 of this summary and claim 1 of this application requires that records be created and maintained in a substantial number of data integration Configuration Tables found in the Processing Database. The Delta Integration Configurator provides a quick and simple way to create and maintain the records found in the data integration configuration tables.

Note: The summary functioning of the Data Integration Configurator that follows uses specific table names as shown in FIG. 1, however, the method described in section 1 of this summary and claim 1 of this application is independent of specific table and field names. The specific table and field names as shown in FIG. 1 and as described in this summary are for illustrative purposes only.

In the common event of a data structure change for an enterprise system, all that will be required to update the data integration will be the use of the Delta Integration Configurator to make updates to the data found in the data integration Configuration Tables. For example, a data structure change such as the one that cost AT&T Wireless an estimated $100 million in lost revenues would simply require

a. the insertion of one record in the top level configuration hierarchy (in the illustration used below, mIntegrationMaster)
b. the configuration of the five or six steps needed for that additional 2^{nd} level step (in the illustration used in the drawings document, sIntegrationDetail)
c. the insertion of one record in the 3^{rd} level hierarchy table for each of the data sets affected by the data structure change to obtain a key, and
d. the insertion of one record in the 4^{th} level hierarchy table to supply the processor the information to obtain the key.

As AT&T Wireless had seven different custom data integration systems affected by the data structure change of the one enterprise system, they were unable to recode those programs for the data structure change in time to prevent catastrophic damage to their business. Using the method of claim 1 of this application and the computer-implemented apparatuses of claims 2 & 3 would have enabled AT&T Wireless to accommodate the data structure change through the quick insertion of the records as noted in a-d for each of the seven data integrations required.

Part 3: A computer-implemented apparatus and usable program code will be scheduled to automatically process the table-driven and data-driven method. (Please see FIG. 1 in the drawings document.) This computer-implemented apparatus and usable program code will be referred to as the Data Integration Processor.

Note: The summary functioning of the Data Integration Processor that follows uses specific table names as shown in FIG. 1, however, the method described in section 1 of this summary and claim 1 of this application is independent of specific table and field names. The specific table and field names as shown in FIG. 1 and as described in this summary are for illustrative purposes only.

Runtime, the Data Integration Processor starts by reading the table mIntegrationMaster to obtain high level information about data sets to be integrated at the scheduled time and the order they are to be processed. The related table sIntegrationDetail is then read to obtain the detail steps that need to be followed in order to accomplish the integration of the specific data set for the steps. As each process type will require a unique set of parameters for the processor to manage the detail step, the table structure breaks off from there. FIG. 1 shows the table sDeltaIntegrationMaster as the next table in the hierarchy for the detail step, however, the unique parameters needed for each process type dictate that the next table in the hierarchy supply different data, so the process type will dictate the appropriate subsequent table for the hierarchy. sDeltaIntegrationMaster is the table to manage the specific process of detecting the new and updated records in the freshly-assembled data in the working tables. It will be quite common for a data set integration to require ten or more detail steps.

After the Data Integration Processor has sequentially executed the steps required in the mIntegrationMaster and sIntegrationDetail, the Data Integration is complete. This can result in a unidirectional integration of just two enterprise systems, or, depending on the configuration data found in the database, can potentially result in a combination of unidirectional and bidirectional integrations of any number of enterprise systems.

What is claimed is:

1: A table-driven and data-driven method to follow a detailed sequence of data integration steps as stored in a Processing Database; map multiple enterprise systems' database structures by data section (e.g. Customer Data, Contact Data, Product Data, Sales Order Data and so forth), storing this Map in a Processing Database; hold within this Processing Database information permitting flexibility of processing, such as supplying records for the destination enterprise system to import versus directly editing information as found in the destination enterprise system database; hold within this Processing Database information as to what the method should process at a given time of day and day of week; hold within this Processing Database details on Business Rules to be applied to the data integration. These business rules will include details such as fields to be integrated as well as fields found within the data section to be left unchanged in the destination database; hold within this Processing Database details on connections to Source and Destination databases for the data integration; hold within this Processing Database a history of the data as submitted to the Destination database; hold within this Processing Database all information needed to be available to enable SQL code to be constructed in runtime; and, read source and destination table data structure to enable proper formatting of system generated code runtime.

2: Also claimed is a computer-implemented apparatus and usable program code to provide a graphic user interface to enable a user to quickly construct the data as needed to implement the table-driven and data-driven method of claim 1. This computer-implemented apparatus and usable program code to provide (not all inclusive):
User Login and configuration of User Options for System Security;
Creation and management of tables holding code translation table;
Creation and management of tables holding data being actively processed and historical data;
Creation and management of data within the tables used to define the detailed sequence of data intergration steps for use in the method of claim 1; and,
Creation and management of data records holding the Business Rules to be implemented by the method claim 1.

3: Also claimed is a computer-implemented apparatus and usable program code to process the table-driven and data-driven method of claim 1. This computer-implemented apparatus and usable program code to:
Follow the sequence of integrations by data section (e.g. Customer Data, Contact Data, Product Data, Sales Order Data and so forth) as required for the time and day of launch as stored within the Processing Database;
Follow the detailed sequence of steps required for an effective data integration of each data section as detailed in the Processing Database for each data section to be integrated;
Verify the validity of new and updated records as found in the working tables;
Either insert records into the Destination database import tables for an import process or directly insert new records into and update existing records within the destination database as needed; and,
Fire off a destination enterprise system's import process if needed to import new records and process updates.
